(19) United States
(12) Patent Application Publication
(10) Pub. No.: US 2024/0026722 A1
(43) Pub. Date: Jan. 25, 2024

(54) DRIVING DEVICE

(71) Applicant: HI-LEX CORPORATION, Takarazuka-shi, Hyogo (JP)

(72) Inventors: Hiroyuki Takaoka, Hyogo (JP); Koji Kuraoka, Hyogo (JP)

(21) Appl. No.: 18/038,721

(22) PCT Filed: Dec. 2, 2021
(86) PCT No.: PCT/JP2021/044192

§ 371 Date: May 25, 2023

(30) Foreign Application Priority Data
Dec. 2, 2020 (JP) 2020-200334

(51) Int. Cl. E05F 15/605; B60J 5/12

(52) U.S. Cl. CPC E05F 15/605; B60J 5/12

(57) ABSTRACT

A driving device is a driving device driving a door that includes an upper door and a lower door rotatably connected to the upper door, and the driving device includes: at least one cable including a first section and a second section that are each laid over from the upper door to the lower door; and a driving portion for increasing a degree of folding of the lower door with respect to the upper door by unwinding the first section, and for suppressing a movement of the lower door with respect to the upper door by winding the second section. This driving device can reduce interference of a lower door with an object around the door.

### TECHNICAL FIELD

The present invention relates to a driving device.

### BACKGROUND ART

Patent Literature (hereinafter, referred to as PTL) 1 discloses a locking device of a folding type back door which folds such that a connecting portion connecting between an upper door and a lower door protrudes outward of a vehicle body.

The locking device disclosed in PTL 1 includes a center lock that is disposed between the upper door and the lower door and integrally holds the upper door and the lower door, and includes a cable that, when a door handle provided at the back door is operated, transmits the operation force to the center lock.

In the device disclosed in PTL 1, when the door handle is operated to open the back door in a fully-closed state, the operating force of the door handle is transmitted to the center lock via the cable. As a result, the locking of the upper door and the lower door by the center lock is released, and thus the back door can be opened while being folded in the middle even when the space behind the vehicle body is narrow.

### CITATION LIST

### Patent Literature

PTL 1

Japanese Patent Application Laid-Open No. 2009-209653

### SUMMARY OF INVENTION

### Technical Problem

The locking device disclosed in PTL 1, however, cannot keep a rotation angle of the lower door when the center lock is released. Thus, there arise a problem in that, when, for example, an external force by a strong wind or the like acts on the lower door during the opening operation of the back door, the swung lower door possibly interferes with a surrounding object.

An object of the present invention is to provide a driving device capable of reducing interference of a lower door with an object around the door.

### Solution to Problem

A driving device of the present invention is a driving device driving a door that includes an upper door and a lower door rotatably connected to the upper door, and the driving device includes: at least one cable including a first section and a second section that are each laid over from the upper door to the lower door; and a driving portion for increasing a degree of folding of the lower door with respect to the upper door by unwinding the first section, and for suppressing a movement of the lower door with respect to the upper door by winding the second section.

### Advantageous Effects of Invention

According to the present invention, it is possible to obtain a driving device capable of reducing interference of a lower door with an object around the door.

### BRIEF DESCRIPTION OF DRAWINGS

FIG. 1 is an external view of an example of a rear portion of vehicle 100 to which a driving device according to an embodiment of the present invention is applied;

FIG. 2A is an enlarged view of an example of door 1 provided with driving device according to the embodiment of the present invention;

FIG. 2B is an enlarged view of an example of door 1 provided with driving device according to the embodiment of the present invention;

FIG. 3 illustrates an exemplary configuration of driving device 10 according to the embodiment of the present invention;

FIG. 4 is an enlarged view of second guide portion 2;

FIG. 5 illustrates an exemplary configuration of driving portion 11;

FIG. 6A is a diagram for describing an operation of driving device 10;

FIG. 6B is another diagram for describing the operation of driving device 10;

FIG. 6C is still another diagram for describing the operation of driving device 10;

FIG. 7A is still another diagram for describing the operation of driving device 10;

FIG. 7B is still another diagram for describing the operation of driving device 10;

FIG. 7C is still another diagram for describing the operation of driving device 10;

FIG. 8A is still another diagram for describing the operation of driving device 10;

FIG. 8B is still another diagram for describing the operation of driving device 10;

FIG. 9A is still another diagram for describing the operation of driving device 10;

FIG. 9B is still another diagram for describing the operation of driving device 10;

FIG. 10A is still another diagram for describing the operation of driving device 10;

FIG. 10B is still another diagram for describing the operation of driving device 10;

FIG. 11A is still another diagram for describing the operation of driving device 10;

FIG. 11B is still another diagram for describing the operation of driving device 10;

FIG. 12A is still another diagram for describing the operation of driving device 10;

FIG. 12B is still another diagram for describing the operation of driving device 10;

FIG. 12C is still another diagram for describing the operation of driving device 10;

FIG. 13A is still another diagram for describing the operation of driving device 10;

FIG. 13B is still another diagram for describing the operation of driving device 10; and

FIG. 13C is still another diagram for describing the operation of driving device 10.

### DESCRIPTION OF EMBODIMENTS

Hereinafter, an embodiment of the present invention will be described in detail with reference to the drawings.

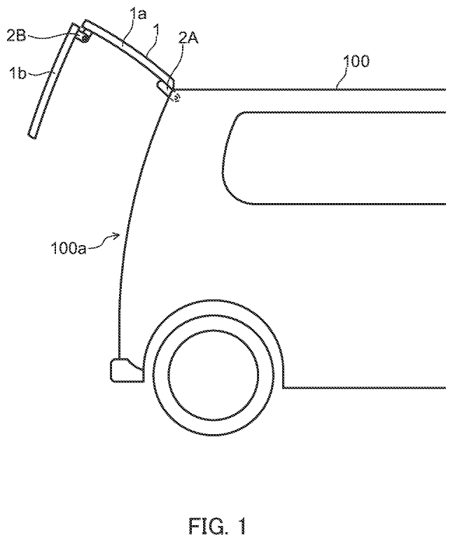

FIG. 1 is an external view of an example of a rear portion of vehicle 100 to which a driving device according to an embodiment of the present invention is applied. Vehicle 100 includes door 1 that puts opening portion 100a formed in the rear portion of vehicle 100 into an opened or closed state.

The opened state is a state in which opening portion 100a is opened, and a state in which a load or the like can be taken in and out of vehicle 100 via opening portion 100a. The closed state is a state in which opening portion 100a is closed.

Door 1 is, for example, a folding type tailgate including upper door 1a and lower door 1b. Note that door 1 is not limited to the tailgate of vehicle 100, and may be, for example, a flip-up type entrance door.

Upper door 1a is rotatably attached to a vehicle body via two hinges 2A₁ and 2A₂. Lower door 1b is rotatably connected to upper door 1a via two hinges 2B₁ and 2B₂. Two hinges 2B₁ and 2B₂ are examples of connecting portions connecting upper door 1a and lower door 1b. In the following description, two hinges 2A₁ and 2A₂ are simply referred to as “hinge 2A” when they are not distinguished from each other. Further, in the following description, two hinges 2B₁ and 2B₂ are simply referred to as “hinge 2B” when they are not distinguished from each other.

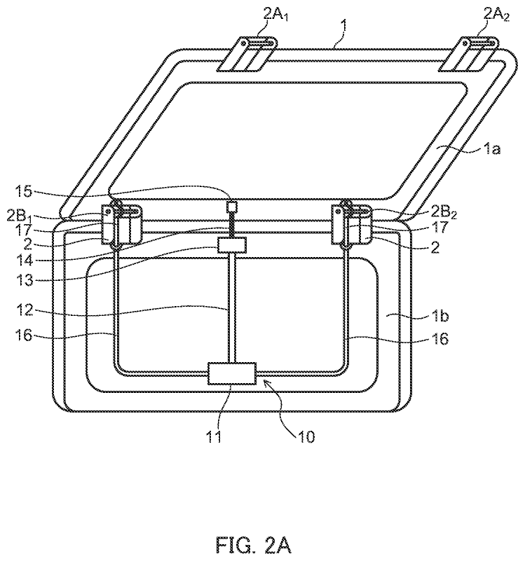

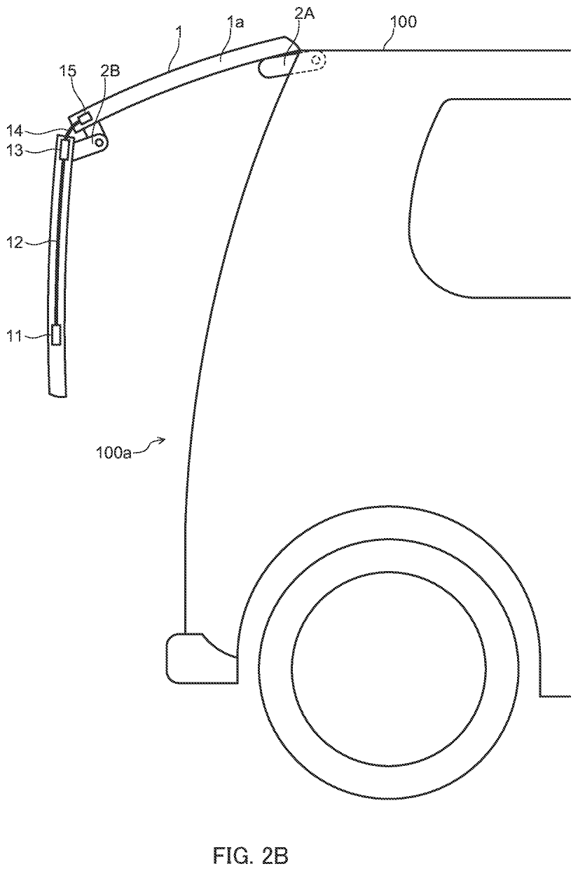

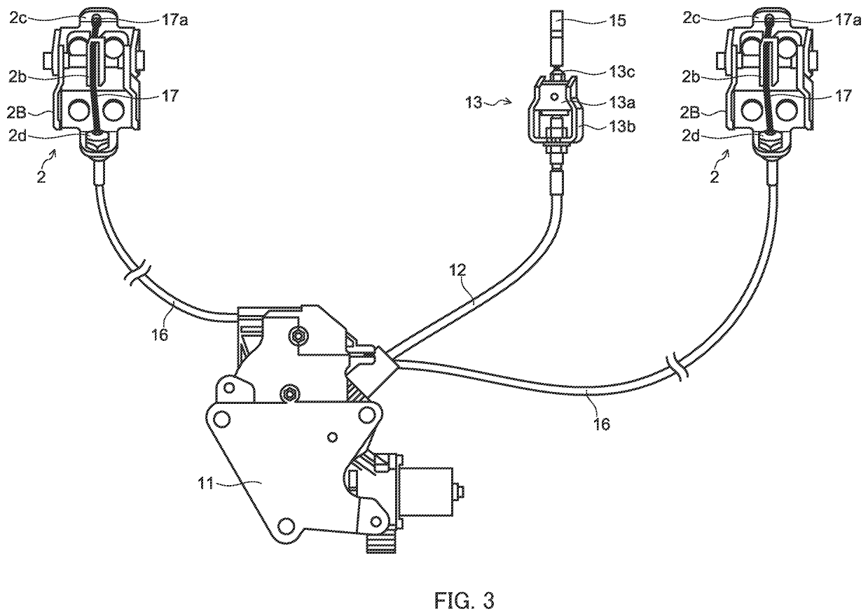

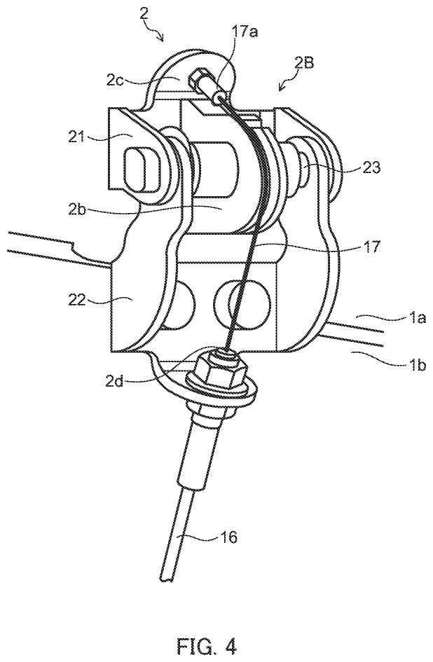

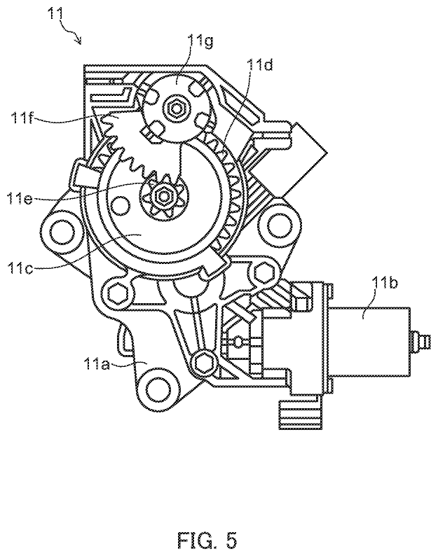

Next, an exemplary configuration of driving device 10 according to the embodiment of the present invention will be described with reference to FIGS. 2 to 5. FIGS. 2A and 2B are enlarged views of an example of door 1 to which driving device 10 according to the embodiment of the present invention is provided. FIG. 2A is a perspective view of door 1, and FIG. 2B is a side view of door 1. FIG. 3 illustrates an exemplary configuration of driving device 10 according to the embodiment of the present invention, FIG. 4 is an enlarged view of second guide portion 2, and FIG. 5 illustrates an exemplary configuration of driving portion 11.

As illustrated in FIG. 2A, two types of hinges 2A and 2B and driving device 10 are provided in door 1. Two types of hinges 2A and 2B are placed apart from each other in the left-right direction of door 1, that is, in the vehicle-width direction.

Note that each of the numbers of hinges 2A and hinges 2B is not limited to two, and may be one or more. For example, when each of numbers of hinges 2A and hinges 2B is one, hinge 2A and hinge 2B are provided in the center portion of door 1 in the vehicle-width direction, and driving device 10 is provided in the center portion of door 1 in the vehicle-width direction or in the vicinity of the edge portion of lower door 1b in the left-right direction.

[Configuration of Driving Device 10]

Driving device 10 includes driving portion 11, outer casing 12, first guide portion 13, cable 14, cable end 15, outer casing 16, cable 17, and second guide portion 2.

[Configuration of Driving Device 11]

Driving portion 11 is a device that generates a driving force for driving lower door 1b by winding and unwinding each cable 14 and cable 17. Upper door 1a is driven by a Power Lift Gate (PLG) unit.

Driving portion 11 is provided at a position spaced apart from hinges 2B by a predetermined distance, in the vicinity of the lower end portion of lower door 1b, and in the vicinity of the center portion of lower door 1b in the left-right direction.

Note that the position where driving portion 11 is provided is not limited to the vicinity of the center portion of lower door 1b in the left-right direction, and may be the vicinity of the edge portion of lower door 1b in the left-right direction. However, when lower door 1b is a door in which a recessed portion recessed from the inside of the vehicle toward the outside of the vehicle is formed, it is preferred that driving portion 11 be provided in a space formed in the recessed portion of lower door 1b.

With such a configuration, the recessed portion of lower door 1b can be effectively used, and the narrowing of a load compartment by driving portion 11 can be avoided.

Driving portion 11 includes a motor and a power transmission portion such as a gear that transmits the rotation of the motor to the drum. Details of the configuration of driving portion 11 will be described later.

[Configuration of First Guide Portion 13]

First guide portion 13 is a member that movably supports cable 14 and changes its guide direction.

As illustrated in FIG. 3, first guide portion 13 includes pulley 13a for conveying cable 14 illustrated in FIG. 2A, bracket 13b for fixing pulley 13a to door 1 illustrated in FIG. 2A, stopper 13c for pulling cable 14 illustrated in FIG. 2A out to the outside of pulley 13a and contacting with cable end 15 to stop the movement of cable end 15 when cable 14 is drawn to the side of pulley 13a.

[Configuration of Cable 14]

Cable 14 is a member for transmitting a tensile force by which upper door 1a and lower door 1b are pulled toward each other based on the driving force generated by driving portion 11. Cable 14 includes a first section that is laid over from upper door 1a to lower door 1b.

Cable 14 is, for example, a flexible cable obtained by twisting a metal wire, a resin fiber wire, or the like.

One end of cable 14 is connected to the drum included in driving portion 11. The other end of cable 14 extends from driving portion 11 toward first guide portion 13, and further extends to cable end 15.

A portion of entire cable 14 from driving portion 11 to first guide portion 13 is covered with outer casing 12 for protecting cable 14.

[Cable End 15]

Cable end 15 is a metallic member for fixing the end of cable 14 to upper door 1a. Cable end 15 is fixed to the vicinity of the lower end of upper door 1a, for example.

[Configuration of Cable 17]

Cable 17 is a cable for suppressing the movement of lower door 1b during the opening operation or closing operation of door 1. Cable 17 includes a second section that is laid over from upper door 1a to lower door 1b. Similarly to cable 14, cable 17 is, for example, a flexible cable obtained by twisting metal wires, resin fiber wires, or the like. [Configuration of Second Guide Portion 2]

Second guide portion 2 is a member that movably supports cable 17 and changes its guide direction. As illustrated in FIG. 4, second guide portion 2 includes hinge 2B, guide 2b, fixing portion 2c, and pullout portion 2d.

[Configuration of Hinge 2B] Hinge 2B includes upper-door hinge portion 21 fixed to upper door 1a, lower-door hinge portion 22 fixed to lower door 1b, and shaft portion 23.

[Configuration of Upper-Door Hinge Portion 21]

Upper-door hinge portion 21 is fixed to upper door 1a with a bolt, by welding, or the like. Cable end 17a is fixed to fixing portion 2c formed in upper-door hinge portion 21. The position to which cable end 17a is fixed may be, for example, a periphery of upper-door hinge portion 21 other than fixing portion 2c formed in upper-door hinge portion 21. The periphery of upper-door hinge portion 21 is, for example, an area between a position a few mm away from the upper end portion of upper-door hinge portion 21 and upper-door hinge portion 21.

Cable end 17a is a metallic member for fixing the end portion of cable 17 to upper door 1a. Cable end 17a is fixed to upper-door hinge portion 21.

[Configuration of Lower-Door Hinge Portion 22]

Lower-door hinge portion 22 is fixed to lower door 1b with a bolt, by welding, or the like. Pullout portion 2d is fixed to lower-door hinge portion 22.

[Configuration of Shaft Portion 23] Shaft portion 23 is a member that rotatably supports lower-door hinge portion 22 with respect to upper-door hinge portion 21 and supports guide 2b. [Configuration of Guide 2b]

Guide 2b is a direction changing portion that changes a moving direction of cable 17 from pullout portion 2d to cable end 17a.

An outer peripheral portion of guide 2b includes a recessed portion, and cable 17 is stretched in the recessed portion. Thus, conveyance by guide 2b can be performed while preventing cable 17 from coming off from guide 2b.

Note that hinge 2B is not limited to be configured as illustrated in FIG. 3 and FIG. 4 as long as hinge 2B is configured to be capable of rotatably supporting lower door 1b with respect to upper door 1a.

[Configuration of Pullout Portion 2d]

Pullout portion 2d is a member for fixing the end portion of outer casing 16 to lower-door hinge portion 22 and pulling cable 17 out from outer casing 16.

Pullout portion 2d is a metallic member formed in a cylindrical shape. A female screw portion is formed around pullout portion 2d. Pullout portion 2d is fixed to lower-door hinge portion 22 by tightening a nut to the female screw portion after the female screw portion is inserted into a through hole formed in lower-door hinge portion 22.

As illustrated in FIG. 5, driving portion 11 includes motor 11b, gear 11d, drum 11c, gear 11e, gear 11f, and drum 11g.

Gear 11d is an annular gear for transmitting a rotational force of motor 11b to drum 11c and drum 11g.

Drum 11c is an annular member for winding and unwinding cable 14. Drum 11c is provided coaxially with gear 11d and rotates with gear 11d.

Gear 11e is a gear for reducing a rotational speed of gear 11d, and is provided coaxially with gear 11d.

Gear 11f is a gear having a sector shape formed as though by cutting a part of a disk.

Gear 11f meshes with gear 11e and rotates in a direction opposite to the rotational direction of gear 11e.

Drum 11g is an annular member for winding and unwinding cable 17 illustrated in FIG. 3. Drum 11g is provided coaxially with gear 11f and rotates with gear 11f.

In driving portion 11 configured as described above, a rotational force of motor 11b is transmitted to gear 11d via a planetary gear and a screw nut (not illustrated).

Drum 11c is rotated by rotating gear 11d, and cable 14 illustrated in FIG. 3 is wound or cable 14 is unwound.

Further, drum 11e is rotated by rotating gear 11d, and gear 11f meshing with gear 11e rotates in a direction opposite to the rotational direction of gear 11e.

Thus, when cable 14 is wound around drum 11c, cable 17 is unwound from drum 11g. Further, when cable 14 is unwound from drum 11c, cable 17 is wound around drum 11g.

Note that, in driving portion 11 according to the present embodiment, the reduction ratio from motor 11b to gear 11f is larger than the reduction ratio from motor 11b to gear 11d, and thus the rotation amount of drum 11g with respect to a predetermined rotation speed of motor 11b is smaller than the rotation amount of drum 11c.

Thus, the unwinding amount of cable 17 by drum 11g is smaller than the winding amount of cable 14 by drum 11c. Thus, the winding amount of cable 17 by drum 11g is smaller than the unwinding amount of cable 14 by drum 11c.

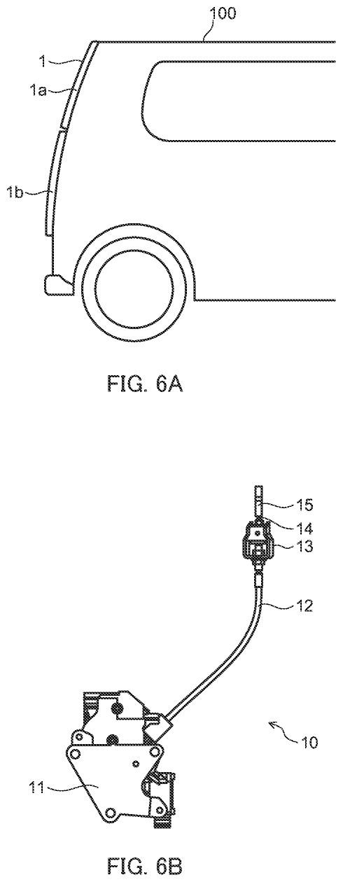

Next, an operation of driving device 10 will be described with reference to FIGS. 6A to 13B. FIGS. 6A to 13B are diagrams for describing an operation of driving device 10.

FIGS. 6A, 7A, 8A, 9A, 10A, 11A, 12A, 13A, and 13C illustrate opening or closing states of door 1.

FIGS. 6B, 6C, 7B, 7C, 8B, 9B, 10B, 11B, 12B, 12C, 13B, and 13C illustrate operation states of driving device 10.

In the following description, an operation of driving device 10 when door 1 is opened will be described first with reference to FIGS. 6A to 9B.

When door 1 is fully closed as illustrated in FIG. 6A, cable end 15 is positioned near first guide portion 13 as illustrated in FIG. 6B. At this time, the winding or unwinding of cable 17 is not performed as illustrated in FIG. 6C.

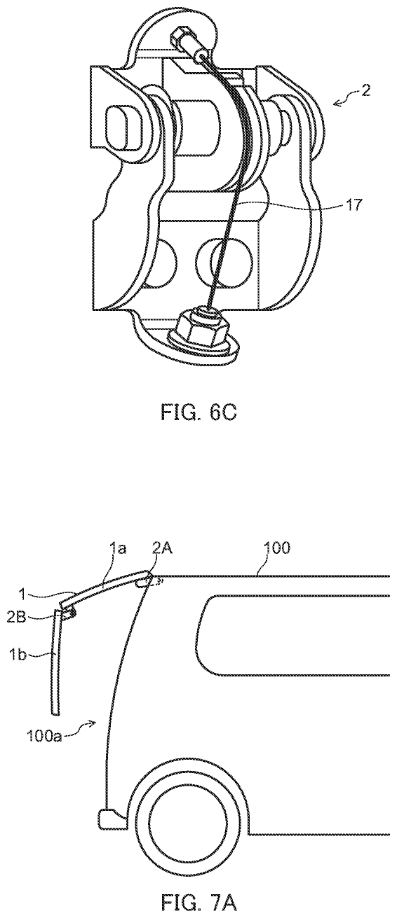

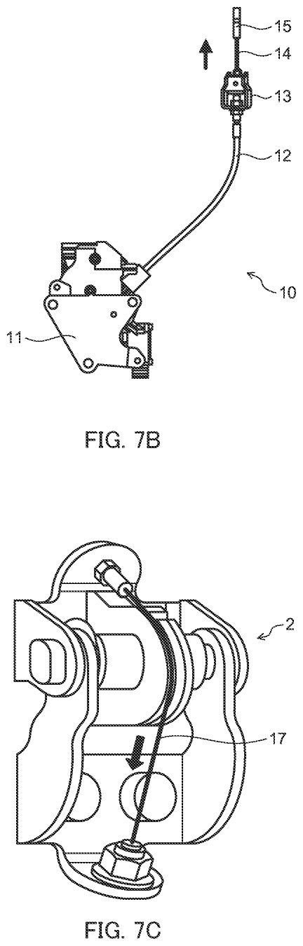

When door 1 in a fully-closed state is opened, as cable 14 is unwound as illustrated in FIG. 7B, cable 17 is wound as illustrated FIG. 7C along with the opening operation of upper door 1a.

This reduces the tensile force by which upper door 1a and lower door 1b are pulled toward each other. Thus, as illustrated in FIG. 7A, lower door 1b hangs down by gravity, and the degree of folding of lower door 1b with respect to upper door 1a increases.

Further, cable 17 is wound as cable 14 is unwound; therefore, even when an external force that decreases the degree of folding of lower door 1b with respect to upper door 1a acts on lower door 1b, for example by strong wind, the angle of lower door 1b with respect to upper door 1a can be maintained at a predetermined angle. Accordingly, interference of lower door 1b with an object around the door can be reduced.

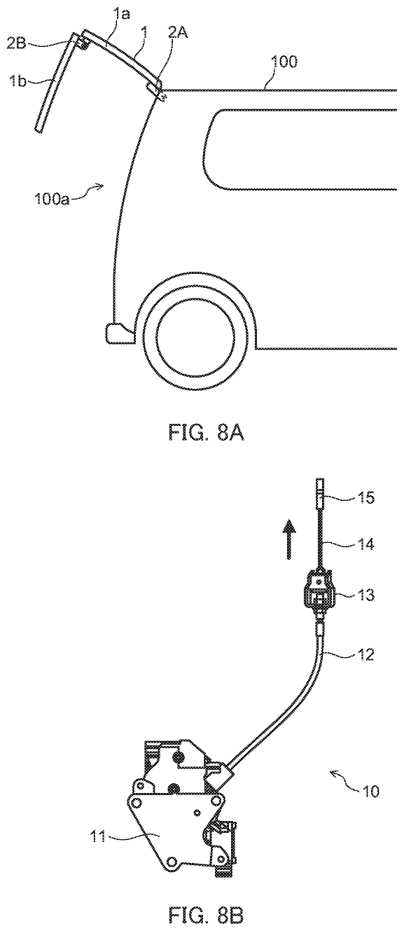

When upper door 1a is further opened, cable 14 is further unwound as illustrated in FIG. 8B. Therefore, as illustrated in FIG. 8A, the degree of folding of lower door 1b with respect to upper door 1a further increases.

As described above, cable 14 is unwound along with the opening operation of upper door 1a, so that the degree of folding of lower door 1b with respect to upper door 1a increases.

Thus, even when, for example, an obstacle such as a person or a wall is present in front of door 1, contacting of lower door 1b with the obstacle can be avoided.

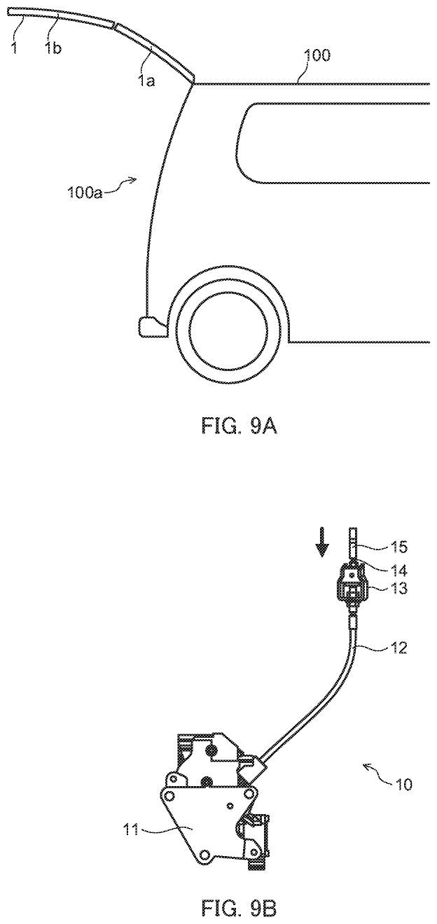

Further, when cable 14 is wound as illustrated in FIG. 9B when upper door 1a is fully opened, the tensile force by which upper door 1a and lower door 1b are pulled toward each other increases. Consequently, as illustrated in FIG. 9A, the flat portion at the end portion of lower door 1b is pushed against the flat portion at the end portion of upper door 1a, and the degree of folding of lower door 1b with respect to upper door 1a decreases, so that door 1 is fully opened.

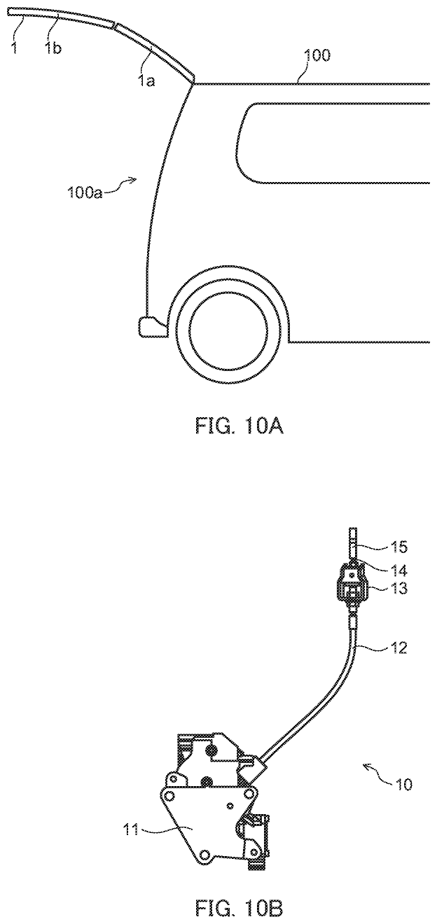

Next, an operation of driving device 10 when door 1 is closed will be described with reference to FIG. 10A to 13B.

When door 1 is fully opened as illustrated in FIG. 10A, cable end 15 is positioned near first guide portion 13 as illustrated in FIG. 10B.

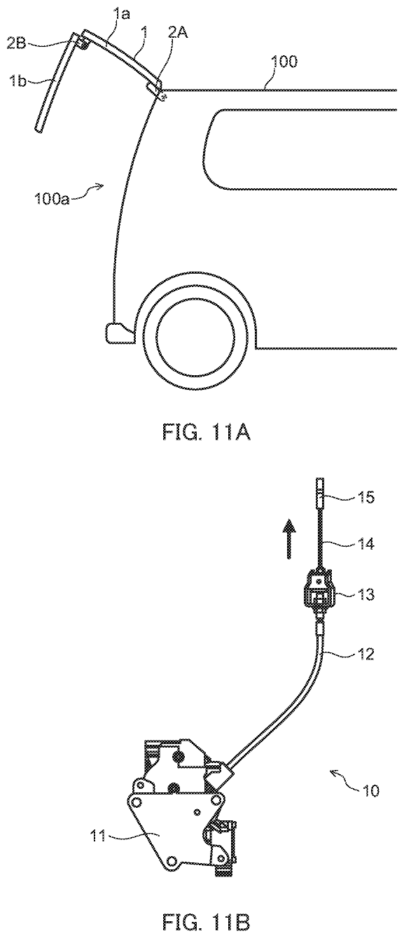

When door 1 in a fully-opened state is closed, cable 14 is unwound as illustrated in FIG. 11B, so that the tensile force by which upper door 1a and lower door 1b are pulled toward each other decreases. Therefore, as illustrated in FIG. 11A, lower door 1b hangs down by gravity, and the degree of folding of lower door 1b with respect to upper door 1a increases.

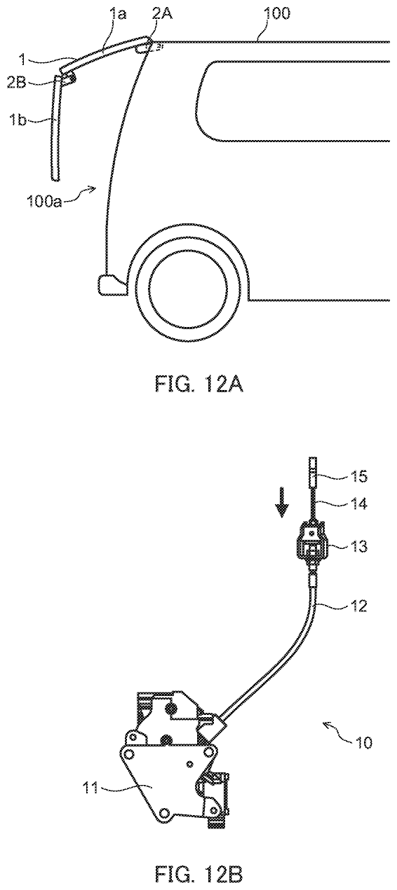

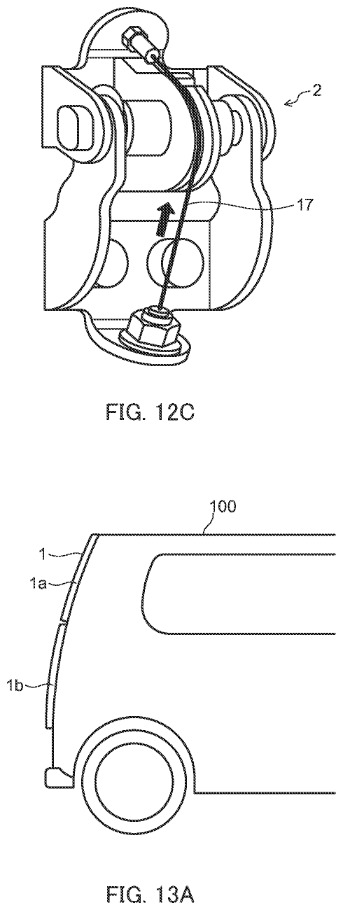

When the closing operation of upper door 1a starts as illustrated in FIG. 12A after cable 14 is unwound for a predetermined amount, as cable 14 is wound as illustrated in FIG. 12B, cable 17 is unwound as illustrated in FIG. 12C along with the closing operation of upper door 1a.

This increases the tensile force by which upper door 1a and lower door 1b are pulled toward each other. Then, the flat portion at the end portion of lower door 1b is pushed against the flat portion at the end portion of upper door 1a, which results in decreasing the degree of folding of lower door 1b with respect to upper door 1a. As described above, cable 14 is wound along with the closing operation of upper door 1b, and thus the contacting of lower door 1a with the vehicle body can be avoided.

Further, cable 17 is unwound as cable 14 is wound; therefore, even when an external force that increases the degree of folding of lower door 1b with respect to upper door 1a acts on lower door 1b, for example by strong wind, the angle of lower door 1b with respect to upper door 1a can be maintained at a predetermined angle. Accordingly, interference of lower door 1b with an object around the door can be reduced.

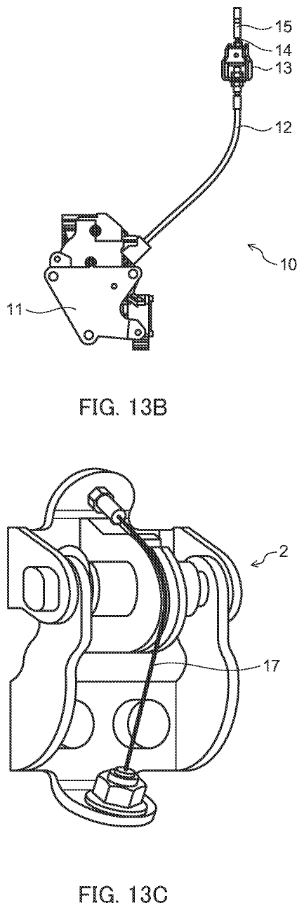

When the closing operation of upper door 1a and the winding of cable 14 continue, door 1 is fully closed while the degree of folding of lower door 1b with respect to upper door 1a is the smallest as illustrated in FIG. 13A. At this time, as illustrated in FIG. 13B, cable end 15 is positioned near first guide portion 13. At this time, the winding or unwinding of cable 17 is not performed as illustrated in FIG. 13C.

Note that, in the present embodiment, the exemplary configuration of driving device 10 driving lower door 1b with two cables has been described, but the exemplary configuration of driving device 10 is not limited thereto, and driving device 10 may be configured so as to drive lower door 1b with one cable.

Specifically, driving device 10 may be configured so that one cable is wound around one pulley provided in driving portion 11. In this case, a portion from the pulley to cable end 15 illustrated in FIG. 2A corresponds to the first section, and a portion from the pulley to fixing portion 2c illustrated in FIG. 4 corresponds to the second section. Then, the attachment position of hinge 2B to door 1, the diameter of guide 2b illustrated in FIG. 4, or the like is adjusted so that the unwinding amount of the second section is smaller than the winding amount of the first section, and the winding amount of the second section is smaller than the unwinding amount of the first section.

Further, driving portion 11 according to the present embodiment may be configured so as to separately control the rotation amounts of drum 11c and drum 11g using the rotational forces of two motors. The rotation amounts of drum 11c and drum 11g can be finely controlled with this configuration, and thus the unwinding amount or the winding amount of the cable can be easily controlled only by changing a control program of driving portion 11 in accordance with the change of specifications of door 1. However, when the rotational force of one motor is used as in driving portion 11 according to the present embodiment, the configuration of driving portion 11 is simplified, so that the manufacturing cost of driving portion 11 and driving device 10 is reduced and the reliability is enhanced.

As described above, driving device 10 according to the present embodiment is configured so that the second section of the cable is wound when the first section of the cable is unwound, and the second section of the cable is unwound when the first section of the cable is wound.

Therefore, when the first section of the cable is unwound to increase the degree of folding of lower door 1b with respect to upper door 1a, the winding of the second section of the cable suppresses the movement of lower door 1b with respect to upper door 1a, so that, even when an external force acts on lower door 1b, the angle of lower door 1b with respect to upper door 1a can be maintained at a predetermined angle.

Further, when the first section of the cable is wound to decrease the degree of folding of lower door 1b with respect to upper door 1a, the unwinding of the second section of the cable suppresses the movement of lower door 1b with respect to upper door 1a, so that, even when an external force acts on lower door 1b, the angle of lower door 1b with respect to upper door 1a can be maintained at a predetermined angle.

Further, even when an external force acts on lower door 1b, the angle of lower door 1b with respect to upper door 1a can be maintained at a predetermined angle, so that interference of lower door 1b with an object around the door during the opening and closing operation of door 1 can be reduced.

Note that, for example, the following aspects are also understood to fall within the technical scope of the present disclosure.

(1) A driving device is a driving device driving a door that includes an upper door and a lower door rotatably connected to the upper door, and the driving device includes: at least one cable including a first section and a second section that are each laid over from the upper door to the lower door; and a driving portion for increasing a degree of folding of the lower door with respect to the upper door by unwinding the first section, and for suppressing a movement of the lower door with respect to the upper door by winding the second section.

(2) The driving portion includes a drum portion for unwinding the first section and winding the second section using a rotational force of one motor.

(3) The driving portion unwinds the second section when winding the first section to decrease the degree of folding of the lower door with respect to the upper door.

(4) A hinge rotatably connecting the lower door to the upper door is provided at the connected position, one end of the second section is connected around the hinge of the upper door, and another end of the second section is connected to the driving portion disposed at the lower door.

(5) A first hinge and a second hinge each rotatably connecting the lower door to the upper door at the connected position are provided to the door apart from each other in a left-right direction, among a plurality of the cables, one end of the second section of the one cable is connected around the first hinge of the upper door, one end of the second section of the another cable is connected around the second hinge of the upper door, and another end of the second section of one cable and another end of the second section of another cable are each connected to the driving portion disposed at the lower door.

It should be understood that the embodiment disclosed herein is illustrative and non-restrictive in all respects. It is intended that the scope of the invention be defined by the appended claims rather than the above description, and that all changes within the meaning and range of equivalency of the claims be included in the claims.

The embodiment of the present invention has been described above. It should be noted that the above description is illustrative of a preferred embodiment of the present invention, and the scope of the present invention is not limited thereto. That is, the configuration of the device and the shape of each part are merely an example, and it is obvious that various modifications and additions to these examples are possible within the scope of the present invention.

### INDUSTRIAL APPLICABILITY

The driving device according to the present invention is useful as a device capable of reducing interference of a lower door with an object around the door.

### REFERENCE SIGNS LIST

1 Door
1a Upper door
1b Lower door
2 Second guide portion
2A Hinge
2A₁ Hinge
2A₂ Hinge
2B Hinge
2B₁ Hinge
2B₂ Hinge
2b Guide
2c Fixing portion
2d Pullout portion
10 Driving device
11 Driving portion
11b Motor
11c Drum
11d Gear
11e Gear
11f Gear
11g Drum
12 Outer casing
13 First guide portion
13a Pulley
13b Bracket
13c Stopper
14 Cable
15 Cable end
16 Outer Casing
17 Cable
17a Cable end
21 Upper-door hinge portion
22 Lower-door hinge portion
23 Shaft portion
100 Vehicle
100a Opening portion

What is claim is:

1. A driving device driving a door that includes an upper door and a lower door rotatably connected to the upper door, the driving device comprising:
at least one cable including a first section and a second section that are each laid over from the upper door to the lower door; and
a driving portion for increasing a degree of folding of the lower door with respect to the upper door by unwinding the first section, and for suppressing a movement of the lower door with respect to the upper door by winding the second section.

2. The driving device according to claim 1, wherein
the driving portion includes a drum portion for unwinding the first section and winding the second section using a rotational force of one motor.

3. The driving device according to claim 1, wherein
the driving portion unwinds the second section when winding the first section to decrease the degree of folding of the lower door with respect to the upper door.

4. The driving device according to claim 1, wherein
a hinge rotatably connecting the lower door to the upper door is provided at the connected position,
one end of the second section is connected around the hinge of the upper door, and
another end of the second section is connected to the driving portion disposed at the lower door.

5. The driving device according to claim 1, wherein
a first hinge and a second hinge each rotatably connecting the lower door to the upper door at the connected position are provided to the door apart from each other in a left-right direction,
among a plurality of the cables, one end of the second section of one cable is connected around the first hinge of the upper door,
one end of the second section of another cable is connected around the second hinge of the upper door, and
another end of the second section of the one cable and another end of the second section of the another cable are each connected to the driving portion disposed at the lower door.
